(19) United States
(12) Patent Application Publication
(10) Pub. No.: US 2002/0067449 A1
(43) Pub. Date: Jun. 6, 2002

(54) Liquid crystal display device and method of manufacturing such a liquid crystal display device

(76) Inventors: Peter Van De Witte, Heerlen (NL); Josephus Paulus Augustinus Deeben, Eindhoven (NL); Armanda Cinderella Nieuwkerk, Eindhoven (NL)

Correspondence Address: U.S. Philips Corporation, 580 White Plains Road, Tarrytown, NY, 10591, US

(21) Appl. No.: 09/897,363

(22) Filed: Jul. 2, 2001

(30) Foreign Application Priority Data
Jul. 10, 2000 (EP) 00202451.1

(51) Int. Cl. G02F 1/1337

(52) U.S. Cl. 349/129

(57) ABSTRACT

Multi-domains are obtained in a liquid crystal cell by introducing different orientation directions at the area of pixel walls.

The invention relates to a liquid crystal display device comprising a layer of liquid crystalline material between a first substrate provided with at least an electrode and a first orientation layer, and a second substrate provided with at least an electrode and a second orientation layer, the display device being divided into active regions and separating regions. Such display devices are used in, for example, television and monitor screens but also in applications for, for example, organizers, mobile telephones etc. are feasible. Moreover, the display device may form part of a larger device in which it may function, for example, as a shutter.

The invention also relates to a method of manufacturing such a display device.

A display device of the type described above is known from European patent application EP-A-00180180 in which a display device is shown which is based on cholesteric liquid crystal material. The display device shown in this document is divided into active regions, in which the cholesteric liquid crystal material can assume different states under the influence of an electric field. In other regions separating the active regions from each other, the cholesteric liquid crystal material remains in one state. This is achieved by locally giving the layer of liquid crystal material a smaller thickness. In said application, this is done by locally providing the two substrates with a projection. However, the provision of such projections requires extra process steps and is very detrimental, notably when using matrix patterns, because the projections cover a disproportionate part of the surface area, notably at smaller pixel dimensions, so that the aperture becomes relatively small.

It is, inter alia, an object of the present invention to obviate the above-mentioned drawbacks as much as possible. It is another object of the invention to provide a method of manufacturing such a display device. To this end, a liquid crystal display device according to the invention is characterized in that the liquid crystalline material is nematic and can assume a plurality of states at the area of separating regions under the influence of an electric field, said states being different from the states in the active region with the same electric field.

Since the liquid crystalline material exhibits a different switching behavior at the area of the separating regions than at the area of the active regions, different active regions are now separated from each other by these separating regions without the necessity of providing one or both substrates with projections.

The difference in switching behavior is obtained, for example, in that at least one of the orientation layers gives molecules of the liquid crystalline material a different orientation at the area of separating regions than at the area of active regions. This can be achieved, for example, by patterned rubbing of an orientation layer of a suitable material; however, the difference in orientation between the molecules of the liquid crystalline material in the active regions and separating regions, respectively, is preferably obtained by means of UV radiation. It is noted that European patent application EP-A-00180180 states the possibility of obtaining the difference between active and separating regions by treatment of the cell wall, but this does not lead to the result that the liquid crystalline material can assume a plurality of states at the area of the separating regions under the influence of an electric field.

A preferred embodiment of a liquid crystal display device according to the invention is characterized in that, at the area of at least one substrate, the molecules of the liquid crystalline material are oriented homeotropically at the area of active regions. Particularly when the liquid crystalline material is homeotropically oriented at the area of both substrates, the liquid crystalline material assumes a similar axial orientation within an active region during switching as is described in SID 95 Digest, pp. 575-578.

This is notably achieved when the molecules of the liquid crystalline material are planar-oriented or oriented at an angle at the area of separating regions. The separating walls then fulfill a similar function as the separating walls of polymer liquid crystalline material described in said publication. However, the manufacture of a display device with such polymer separating walls requires an extensive process; notably, long mask illumination times are required for polymerization.

On the other hand, it is possible that the liquid crystalline material in the active regions is homeotropically oriented at the area of one of the two substrates and is amorphous planar (HAN orientation) or, for example, planar on both sides (twisted-nematic or not twisted-nematic) on the other substrate, while the liquid crystalline material is then homeotropically oriented in the separating regions at the area of both substrates. If the liquid crystalline material has a planar orientation on both sides (twisted-nematic), the liquid crystalline material assumes said axial orientation (as described in SID 95, pp. 575-578) in a voltageless state within an active region.

Since the separating regions switch during use, their electro-optical state changes; the state induced by switching is presumably the cause of assuming the axial symmetry within the active regions. It is true that the light transmissivity of the separating regions changes due to switching. However, this can be easily hidden from view by means of generally known and simple black-matrix techniques.

To prevent the light properties of the active regions from being influenced by the separating regions, the width of a separating region is not more than 10% and preferably not more than 5% of the width of an active region.

When switching, for example, from a homeotropic orientation to an axial orientation, the properties of the liquid crystalline material at the area of the separating regions influence the switching behavior of the liquid crystalline material in the active regions so that long relaxation times occur. This can be presented by locally giving the liquid crystalline material molecules a preferred orientation at the area of active regions, for example, by modifying the orientation layer on one substrate in patterns. It is alternatively possible that the electrode has a slit at the area of the active region.

A method of manufacturing a liquid crystal display device comprising a layer of liquid crystalline material between a first substrate provided with at least an electrode and a first orientation layer, and a second substrate provided with at least an electrode and a second orientation layer, the display device being divided into active regions and separating regions, is characterized in that at least one of the substrates is provided with a layer of orienting material and subsequently the orienting properties of the layer of orienting material are modified at the area of active regions or at the area of separating regions.

These and other aspects of the invention are apparent from and will be elucidated with reference to the embodiments described hereinafter.

In the drawings:

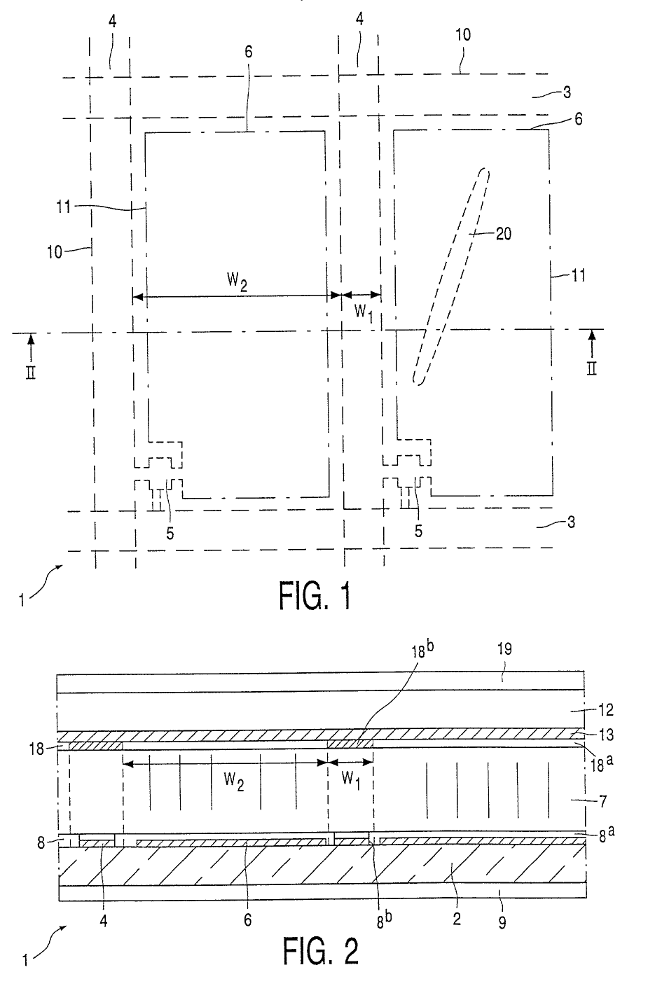

FIG. 1 is a plan view of a part of a display device according to the invention, and

FIG. 2 is a diagrammatic cross-section taken on the line II-II in FIG. 1.

The Figures are diagrammatic and not drawn to scale. Corresponding components are generally denoted by the same reference numerals.

FIG. 1 is a plan view of a part of a matrix of pixels, and FIG. 2 is a cross-section of a liquid crystal display device 1 based thereon. A (synthetic material or glass) substrate 2 is provided with a conducting pattern 3, 4 of, for example, aluminum, ITO or another suitable material. In this embodiment, the pattern 3, 4 comprises row electrodes 3 and column electrodes 4 with transistors 5 at the area of crossings of the row and column electrodes in this embodiment, which transistors are selected by means of the row electrodes and transfer drive voltages presented to the column electrodes to picture electrodes 6 via the transistors 5 shown diagrammatically (in FIG. 1, the edges of the row and column electrodes 3, 4 are denoted by broken lines 10, while the edges of the picture electrodes are denoted by dot-and-dash lines 11).

A second substrate 12 is provided with a counter electrode 13. A liquid crystal material 7 having a negative Δε is present between the two substrates, for example, BL 109 of the firm of Merck. To orient the liquid crystal molecules, the conducting pattern 3, 4, 6 on the first substrate 2 is coated with an orienting layer 8, for example, a polyimide JALS 204 of the firm of JSR. Similarly, the second substrate 12 is coated with an orienting layer 18, of the same polyimide in this example. By means of ultraviolet radiation (with a main wavelength of 315 nm in this embodiment) it is possible to bring about a chemical variation in this layer so that a different orientation (preferred direction, tilt angle) of the liquid crystal molecules is induced. By illuminating the orienting layer 8 in patterns, a different orientation is obtained at the area of illuminated regions 8^{b} than at the area of non-illuminated regions 8^{a}. At the area of the non-illuminated regions 8^{a}, in this embodiment at the area of picture electrodes 6, the liquid crystal material 7 in the voltageless state is oriented homeotropically. At the area of the illuminated regions 8^{b} between the picture electrodes 6, the liquid crystal material 7 in a voltageless state is planar-oriented on, for example, one side (hybrid orientation or HAN alignment). If necessary, the region 18^{b} may also be illuminated (in a similar manner); in that case, separating regions with a planar orientation on both substrates in a voltageless state are obtained between the picture electrodes with a homeotropic orientation. The width w₁ of the separating regions is 3% of the width w₂ of an active region in this embodiment.

The device is further provided in the conventional manner with polarizers 9, 19 (crossed in this embodiment). In the non-illuminated parts (the actual pixels), the liquid crystal material in the voltageless state is homeotropic and no light is passed between crossed polarizers. In the separating regions, the liquid crystal material in the voltageless state (in this embodiment) is partially light-transmissive due to birefringence. When applying a voltage, the liquid crystal material will partly or not partly transmit light at the area of the pixel, dependent on the applied voltage. In the separating regions, the light transmissivity may be influenced by voltages on the row and column electrodes. The separating regions are therefore preferably covered with a black mask in a generally known manner.

Although the physical phenomena are not clearly explicable on a microscopic level, such an interaction between the molecules in the separating regions and the molecules at the area of the pixels occurs during switching that the angle dependence of a cell is considerably smaller and the molecules assume an axial orientation which is comparable with that obtained by means of the techniques as described in SID 95 Digest, pp. 575-578.

The invention is of course not limited to the embodiments described hereinbefore. For example, as stated, both orientation layers 8, 18 may be illuminated in patterns. The liquid crystal material may comprise a chiral component so that it exhibits a twist in the planar state. Alternatively, parts 8^{a}, 18^{a} of the orientation layers 8, 18 may be illuminated in such a way that the liquid crystal material 7 in the voltageless state has a (partial) planar orientation at the area of the picture electrodes, while separating regions with a homeotropic orientation are obtained in the voltageless state on both substrates at the area of the regions 8^{b}, 18^{b}. Long relaxation times are prevented by locally giving the liquid crystalline material molecules a preferred orientation at the area of active regions, for example, by modifying the orientation layer on one substrate in patterns. It is alternatively possible that the electrode has a slit at the area of the active region, as is shown by means of broken lines 20 in FIG. 1.

The protective scope of the invention is not limited to the embodiments described. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A liquid crystal display device comprising a layer of liquid crystalline material (7) between a first substrate (2) provided with at least an electrode (6) and a first orientation layer (8), and a second substrate (12) provided with at least an electrode (13) and a second orientation layer (18), the display device being divided into active regions and separating regions, characterized in that the liquid crystalline material is nematic and can assume a plurality of states at the area of separating regions under the influence of an electric field, said states being different from the states in the active region with the same electric field.

2. A liquid crystal display device as claimed in claim 1, characterized in that at least one of the orientation layers (8, 18) gives molecules of the liquid crystalline material (7) a different orientation at the area of separating regions than at the area of active regions.

3. A liquid crystal display device as claimed in claim 2, characterized in that the difference in orientation between the molecules of the liquid crystalline material in the active regions and separating regions, respectively, is obtained by means of UV radiation.

4. A liquid crystal display device as claimed in claim 1, characterized in that, at the area of at least one substrate, the molecules of the liquid crystalline material are planar-oriented or oriented at an angle at the area of active regions.

5. A liquid crystal display device as claimed in claim 4, characterized in that the molecules of the liquid crystalline material are oriented homeotropically at the area of separating regions.

6. A liquid crystal display device as claimed in claim 1, characterized in that, at the area of at least one substrate, the molecules of the liquid crystalline material are oriented homeotropically at the area of active regions.

7. A liquid crystal display device as claimed in claim 6, characterized in that the molecules of the liquid crystalline material are planar-oriented or oriented at an angle at the area of separating regions.

8. A liquid crystal display device as claimed in claim 1, characterized in that the separating regions constitute a closed pattern.

9. A liquid crystal display device as claimed in claim 1, characterized in that, at the area of at least one substrate, the display device comprises means for locally giving the liquid crystalline material molecules a preferred orientation at the area of active regions.

10. A liquid crystal display device as claimed in claim 9, characterized in that the orientation layer on one substrate is modified in patterns.

11. A liquid crystal display device as claimed in claim 9, characterized in that the electrode has at least a slit at the area of the active region.

12. A liquid crystal display device as claimed in claim 1, characterized in that the width of the separating regions is not more than 10% of the width of an active region.

13. A liquid crystal display device as claimed in claim 11, characterized in that the width of the separating region is not more than 5% of the width of an active region.

14. A method of manufacturing a liquid crystal display device comprising a layer of liquid crystalline material between a first substrate provided with at least an electrode and a first orientation layer, and a second substrate provided with at least an electrode and a second orientation layer, the display device being divided into active regions and separating regions, characterized in that at least one of the substrates is provided with a layer of orienting material and subsequently the orienting properties of the layer of orienting material are modified at the area of active regions or at the area of separating regions.

15. A method as claimed in claim 14, characterized in that the orienting properties of the layer of orienting material are modified by means of UV radiation.
